(19) United States
(12) Patent Application Publication
(10) Pub. No.: US 2013/0240309 A1
(43) Pub. Date: Sep. 19, 2013

(54) Brake Disk Assembly

(71) Applicant: Wayne-Ian Moore, Changhua County (TW)

(72) Inventor: Wayne-Ian Moore, Changhua County (TW)

(21) Appl. No.: 13/874,487

(22) Filed: May 1, 2013

Related U.S. Application Data
(63) Continuation-in-part of application No. 13/272,239, filed on Oct. 13, 2011.

(51) Int. Cl. F16D 65/12

(52) U.S. Cl. CPC F16D 65/123
USPC 188/218 XL

(57) ABSTRACT

A brake disk assembly includes a friction disk clamped between the supporting plate and the fixing plate. The friction disk is axially movable relative to the supporting plate and the fixing plate. The contact area between the friction disk and either one of the supporting plate and the fixing plate is increased to firmly connect the friction disk and the supporting plate and the fixing plate.

### CROSS-REFERENCE TO RELATED APPLICATION

This application is a continuation-in-part of U.S. patent application Ser. No. 13/272,239, filed Oct. 13, 2011.

### BACKGROUND OF THE INVENTION

1. Field of the Invention

The present invention relates to a brake disk assembly, and more particularly to a brake disk assembly with a friction disk movably clamped between two plates.

2. Description of the Related Art

A conventional brake disk assembly for a bicycle is fixed to the axle of the wheel and the calipers clamp a friction disk of the brake disk assembly to stop the wheel. High temperature is generated during clamping and the heat is transmitted to the spokes of the bicycle and even soften the brake disk assembly which becomes weak and easily deformed.

An improved conventional brake disk assembly generally includes a supporting plate with a friction disk connected to an external periphery of the supporting plate. The supporting plate has a notch, and the friction plate has another notch which is matched with the notch of the supporting plate. There is a fastening member extending through the two aligned notches and connecting the supporting plate and the friction plate. The sudden braking force is buffered and absorbed by a gap between the supporting plate and the friction plate.

However, the supporting plate and the friction plate are joined merely through several connection points therebetween, which is sometimes not strong enough to bear a high clamping force when braking.

The present invention intends to provide a brake disk assembly which improves the shortcomings of the conventional connection between the supporting plate and the friction disk.

### SUMMARY OF THE INVENTION

An objective of the present invention is to provide an improved brake disk assembly.

To achieve the objective, the brake disk assembly includes an annular supporting plate, an annular fixing plate and a friction disk coaxially sandwiched in between the supporting plate and the fixing plate. The supporting plate has an external periphery defining a plurality of recessed teeth and at least one mounting hole. The fixing plate defines at least one mounting hole in an external periphery thereof. The friction disk has a central aperture defined by an internal circumference thereof. The friction disk further includes a plurality of internal teeth extending from the internal circumference for engagement with the recessed teeth of the supporting plate.

Further, a fastener is included to pass through the mounting holes of the supporting plate and the fixing plate to secure the supporting plate and the fixing plate together and to allow limited axial float of the internal teeth, along with other parts, of the friction disk in between the supporting plate and the fixing plate. In particular, the supporting plate is overlapped with the friction disk with the external periphery thereof to facilitate heat dissipation.

As such, the friction disk is movably connected between the supporting plate and the fixing plate. Comparing to the prior art, a larger contact area between the friction disk and either one of the supporting plate and the fixing plate is generated so that the brake disk assembly is more reliable and the wearing of the friction disk is reduced.

Preferably, the supporting plate and the fixing plate are shaped to be correspondent to the central aperture. The supporting plate and the fixing plate respectively protrude from two opposite sides of the friction disk.

Moreover, the supporting plate has mounting holes, and the fixing plate has mounting holes corresponding to that of the supporting plate so that bolts or rivets may be used to extend through the mounting holes of the supporting plate and the fixing plate to secure the supporting plate and the fixing plate together. And, the friction disk defines a plurality of ventilation holes therein for heat dissipation.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a brake disk assembly in accordance with the present invention;

FIG. 2 is a partially assembled view of the brake disk assembly in accordance with the present invention;

FIG. 3 is a perspective view of the brake disk assembly in accordance with the present invention;

FIG. 4 is a cross-sectional view of the brake disk assembly along line A-A in FIG. 3; and

FIG. 5 is a cross-sectional view of the brake disk assembly along line B-B in FIG. 3.

### DETAILED DESCRIPTION OF PREFERRED EMBODIMENT

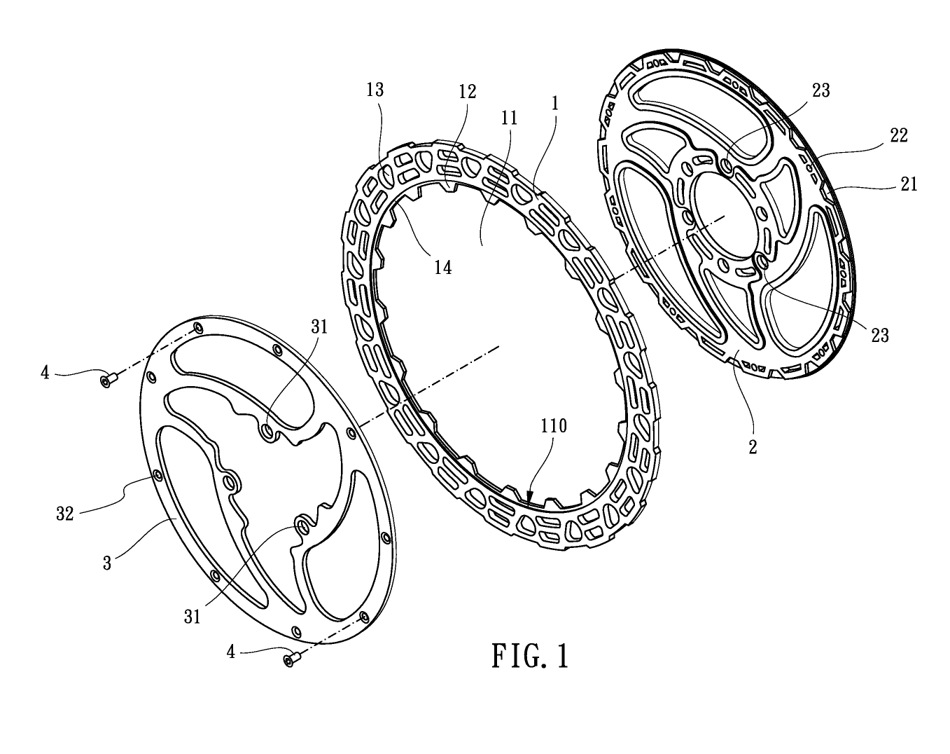

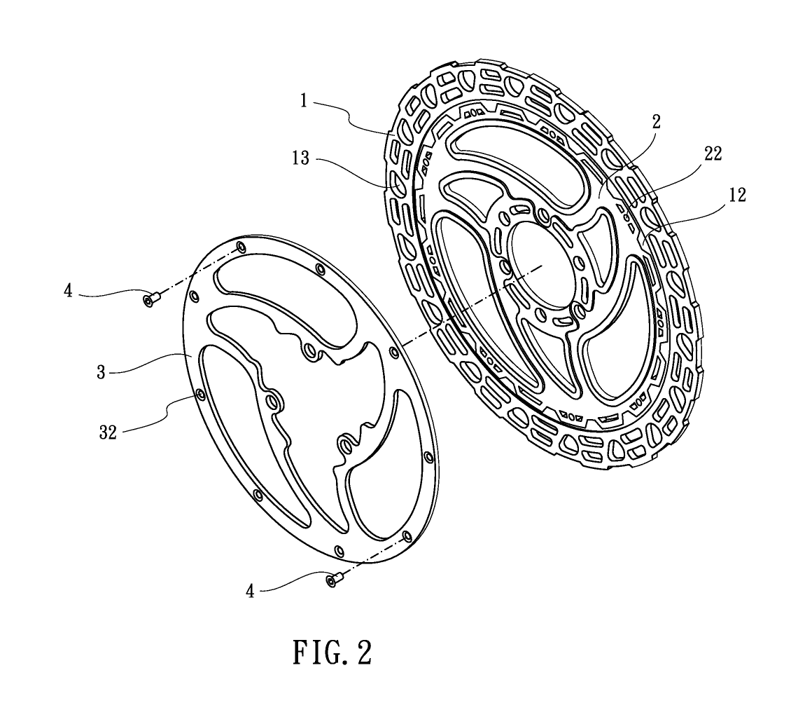

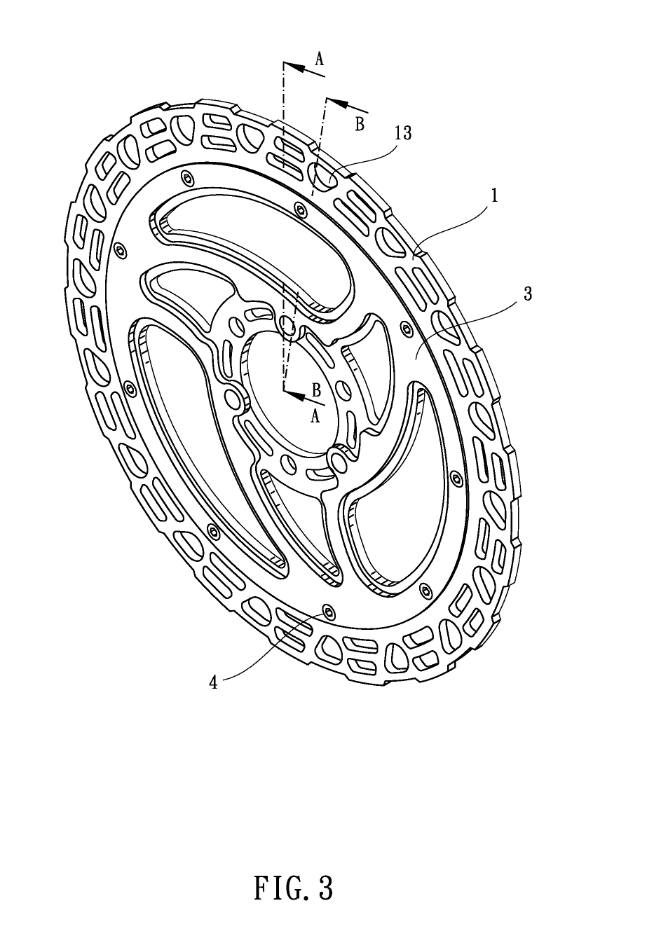

Referring to FIGS. 1 to 5, the brake disk assembly for a bicycle according to the preferred embodiment of the present invention comprises a friction disk 1, an annular supporting plate 2, an annular fixing plate 3 and a plurality of fasteners 4. The friction disk 1 is coaxially sandwiched in between the supporting plate 2 and the fixing plate 3.

The friction disk 1 has an internal flange 14 radially extending from an internal circumference 110 thereof, a central aperture 11 defined by the internal circumference 110 thereof, and a plurality of internal teeth 12 extend from the internal flange 14. The internal teeth 12 are formed equidistantly. The friction disk 1 has a plurality of ventilation holes 13 which have different sizes. Heat generated during braking escapes from the brake disk assembly via the ventilation holes 13.

The supporting plate 2 corresponds in shape to the central aperture 11 of the friction disk 1 to be partly received in one side of the central aperture 11 in the friction disk 1. The supporting plate 2 has a plurality of recessed teeth 21 defined in an external periphery thereof and corresponding to the internal teeth 12 of the friction disk 1. The internal teeth 12 of the friction disk 1 are engaged with the recessed teeth 21 of the supporting plate 2 so that braking torque can be transferred from the friction disk 1 to the supporting plate 2 via the teeth engagement. In this embodiment, there are eighteen internal teeth 12 and eighteen recessed teeth 21. Moreover, as shown in FIG. 5, the supporting-plate 2 has an external diameter larger than the internal diameter of the internal flange 14 of the friction disk 1 so that the supporting plate 2 is overlapped with the friction disk 1 with the external periphery thereof.

The fixing plate 3 corresponds in shape to the central aperture 11 of the friction disk 1 to be partly received in the other side of the central aperture 11 in the friction disk 1 and opposite to the recessed teeth 21 of the supporting plate 2. Moreover, as shown in FIG. 5, the fixing plate 3 has an external diameter larger than an internal diameter of the internal flange 14 of the friction disk 1, so the fixing plate 3 is overlapped with the friction disk 1 with the external periphery thereof.

As shown in FIG. 1, the annular supporting plate 2 further defines at least three engaging holes 23 arranged in a circle, and the annular fixing plate 3 further defines at least three engaging holes 31 arranged in a circle corresponding to that of the supporting plate 2. The engaging holes 23, 31 of the supporting plate 2 and the fixing plate 3 are arranged for mounting of a hub (not shown) onto the brake disk assembly.

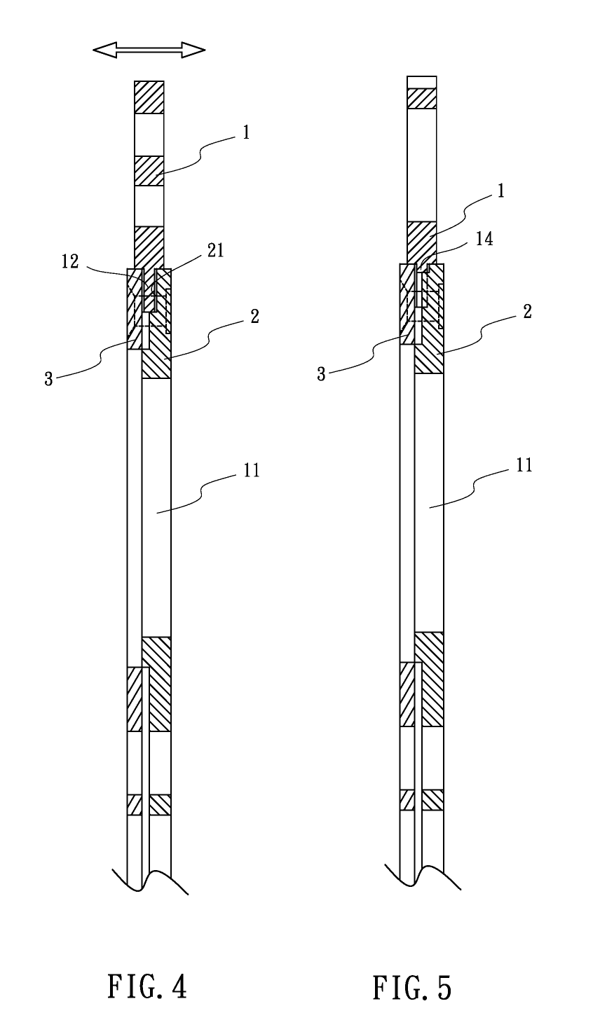

Moreover, the supporting plate 2 has a plurality of mounting holes 22 defined in the external periphery thereof, and the fixing plate 3 has a plurality of mounting holes 32 defined in the external periphery thereof and corresponding to the mounting holes 22 of the supporting plate 2. The fasteners 4, such as bolts or rivets extend through the mounting hole 22 of the supporting plate 2, the central aperture 11 of the friction disk 1 and the mounting hole 32 of the fixing plate 3 to secure the supporting plate 2 and the fixing plate 3 together and to allow limited axial float of the internal teeth 12, along with other parts, of the friction disk 1 in between the supporting plate 2 and the fixing plate 3, as shown in FIG. 4. That is, the friction disk 1 is axially movable with respect to either one of the fixing plate 3 and the supporting plate 2. Specifically, a clearance is defined among the internal teeth 12 of the friction disk 1, the supporting plate 2 and the fixing plate 3. The arrangement is such as to allow the limited axial float of the internal teeth 12, along with other parts of the friction disk 1, in between the supporting plate 2 and the fixing plate 3, as indicated by a left right arrow in FIG. 4.

As shown in FIG. 5, the supporting plate 2 is partly fitted in the side of the central aperture 11 of the friction disk 1 with the external periphery thereof in confronting relation to one side of the internal flange 14 of the friction disk 1, and the fixing plate 3 is partly fitted in the opposite side of the central aperture 11 of the friction disk 1 with the external periphery thereof in confronting relation to an opposite side of the internal flange 14 of the friction disk 1. As a result of the internal flange 14, a larger contact area is created between the friction disk 1 and either one of the supporting plate 2 and the fixing plate 3.

Compared to the prior art, the brake disk assembly of the present invention employs the larger contact area between the friction disk 1 and either one of the supporting plate 2 and the fixing plate 3, and therefore the bonding strength among the three parts 1, 2, 3 is enhanced, and heat generated while braking can be effectively transferred from the friction disk 1 through the supporting plate 2 and the fixing plate 3 by 360 degrees to the hub or core of the wheel. However, in the prior art, the heat can only be transferred locally radially from an outer friction disk to an inner supporting plate via each rivet boss. This lower thermal transfer can lead to brake-fade which his caused by a buildup of heat in the braking surfaces.

In general, friction between the friction disk 1 and two lining pads of a brake system of the bicycle causes high heat so that one portion of the friction disk 1 clamped by the lining pads tends to be deformed. The larger the external diameter of the friction disk 1 is, the more obvious irregular deformation along the external periphery of the friction disk 1 will occur, and the deformation affects the lining pads to clamp the friction disk 1 centrally during the rotation. Therefore, the present invention provides a feature that the friction disk 1 is axially movable between the supporting plate 2 and the fixing plate 3 so that even though the deformation is occurred, the friction disk 1 can be clamped centrally by the lining plates to further prevent it from undesired deformation and this increases the life time of the brake disk assembly. Thus, the brake disk assembly of the present invention is more reliable and the wearing of the friction disk 1 is reduced.

It is to be understood that the disclosed embodiments are illustrative in nature and the invention is not to be limited to any one or more embodiments except as set forth in the following claims.

What is claimed is:

1. A brake disk assembly, comprising:
an annular supporting plate having an external periphery defining a plurality of recessed teeth and at least one mounting hole;
an annular fixing plate defining at least one mounting hole in an external periphery thereof;
a friction disk coaxially sandwiched in between the supporting plate and the fixing plate, and having a central aperture defined by an internal circumference thereof and a plurality of internal teeth extending from the internal circumference for engagement with the recessed teeth of the supporting plate; wherein the supporting plate is overlapped with the friction disk with the external periphery thereof; and
at least one fastener passing through the mounting holes of the supporting plate and the fixing plate to secure the supporting plate and the fixing plate together and to allow limited axial float of the internal teeth, along with other parts, of the friction disk in between the supporting plate and the fixing plate.

2. The brake disk assembly of claim 1, wherein the friction disk further includes an internal flange radially extending from an inner wall the internal circumference, and the internal teeth extend from the internal flange;
and the supporting plate is at least partly fitted in one side of the central aperture of the friction disk with the external periphery thereof in confronting relation to one side of the internal flange of the friction disk.

3. The brake disk assembly of claim 1, wherein the fixing plate is overlapped with the friction disk with the external periphery thereof in which the mounting hole is defined.

4. The brake disk assembly of claim 3, wherein the friction disk further includes an internal flange radially extending from the internal circumference, and the internal teeth extend from the internal flange; and the supporting plate is at least partly fitted in one side of the central aperture of the friction disk with the external periphery thereof in confronting relation to one side of the internal flange of the friction disk, and the fixing plate is at least partly fitted in an opposite side of the central aperture of the friction disk with the external periphery thereof in confronting relation to an opposite side of the internal flange of the friction disk.

5. The brake disk assembly of claim 1, wherein the fastener passing through the mounting hole of the fixing plate, the central aperture of the friction disk and the mounting hole of the supporting plate to allow the limited axial float of the internal teeth with respect to either one of the supporting plate and the fixing plate.

6. The brake disk assembly of claim 1, wherein the annular supporting plate further defines at least three engaging holes arranged in a circle, and the annular fixing plate further defines at least three engaging holes arranged in a circle corresponding to that of the supporting plate; the engaging holes of the supporting plate and the fixing plate are arranged for mounting of a hub onto the brake disk assembly.
